(19) United States
(12) Patent Application Publication
(10) Pub. No.: US 2005/0097107 A1
(43) Pub. Date: May 5, 2005

(54) Seamless Affiliated Link System

(76) Inventor: Terence M. Burt, Canton, MI (US)

Correspondence Address: ARTZ & ARTZ, P.C., 28333 TELEGRAPH RD., SUITE 250, SOUTHFIELD, MI, 48034, US

(21) Appl. No.: 10/605,821

(22) Filed: Oct. 29, 2003

(51) Int. Cl. G06F 17/00

(52) U.S. Cl. 707/100

(57) ABSTRACT

A seamless affiliated link system includes providing a HTTP browser with encoded uniform resource locators (URLs) from bookmarks, manual entry, and non-HTTP clients, and sending the browser an identifier in response to requests for these URLs. It further includes a host server rewriting key (URLs) as a processing script. The processing script checks identifiers from the browser and referring website, thereby determining whether the requested URL is affiliated or non-affiliated. The processing script increases the search engine importance of key URLs, by performing affiliated processing in response to affiliated URLs, and processing the requested URL in response to non-affiliated URLs.

### BACKGROUND OF INVENTION

The present invention relates generally to Internet communications, and more particularly, to a seamless affiliated link system.

As is well known, computer programs are lists of commands that can be executed with or without user interaction. Various programming languages have been developed, such as BASIC, C, C++, COBOL, FORTRAN, ADA, PASCAL, Perl and PHP. Each language has a unique set of key words (words that it particularly understands) and a special syntax organizing program instructions. In the context of the Internet World Wide Web (www), computer programs, sometimes called scripts, are often used on servers to process user requests sent by Web browser clients.

One particular type of computer script, called a cloaking script, has been in widespread use by webmasters for quite some time. These scripts are programs that check an Internet Protocol (IP) address of a requesting browser (or search engine “spider”) and use that address to determine which Web page to serve. Essentially, they “cloak” the actual page from the spider and feed it an optimized version of the page. The actual version of the page is then served to everybody else.

In the context of the World Wide Web (www), website owners often generate traffic to their websites by incorporating their URLs into directories, affiliate programs, other websites, emailed newsletters and notices, and various other locations and processes. An affiliate program is a process whereby a commercial website owner pays someone to send traffic to, and/or generate orders through, the owner's website. This traffic and/or orders might similarly be generated from directories, affiliate programs, websites, emailed newsletters and notices, or various other locations and processes. Website owners often need to track the traffic and/or orders generated by these various processes. We shall term any such process an “affiliated process”, the URLs “affiliated links”, the website owners “site owners”, and the affiliated process owners “affiliates.” In this context, it should be noted that site owners can also be affiliates of their own websites.

Link mechanisms most widely used by site owners to track affiliated processes specify each affiliated link as an encoded “Uniform Resource Locator”(URL) linking to the owner's website. These mechanisms may further employ the use of browser identifier files (“cookies”) to assist in tracking. The URL is an address identifying the location of a file on the Internet, consisting of the protocol, the computer on which the file is located, and the file's location on that computer. The “encoded URL” additionally contains the affiliate's unique code or affiliate ID in the “query string”, which consists of a question mark followed by a series of “name/value pairs” appended to the URL. A cookie is a small file written to the browser computer's hard drive to track the browser as it visits different pages of the owner's website. The encoded URLs linking to the owner's website, possibly in conjunction with cookies, enable the site owner to track separately the traffic and/or orders from each affiliate and to compensate each affiliate accordingly.

Current link mechanisms require that a separate URL be used by each affiliate. This is a disadvantage from a “Search Engine Optimization” (SEO) point of view because most search engines increase the importance of a URL for each link pointing to it (“link popularity”). Additionally, some search engines increase the importance of a URL based on the number of browser visits to that URL (“link traffic”). Current affiliated links do nothing to increase the SEO importance of the site owner's key pages.

It would be advantageous to increase the importance of a site owner's key pages by having all affiliated links point thereto, which is something that current systems have not yet achieved.

Cloaking scripts check for the IP address of the “requester,” whereas checking the IP address (or domain name) of the “referer”(sic) would enable linking directly to a site owner's key pages, rather than to encoded URLs.

The disadvantages associated with current linking techniques have made it apparent that a new technique is needed to increase the SEO importance of the site owner's key pages. The new technique should facilitate building both link popularity and link traffic for these pages. The present invention is directed to these ends.

### SUMMARY OF INVENTION

The present invention provides a seamless affiliated link system and a method for operating the seamless affiliated link system.

In accordance with one aspect of the present invention, a seamless affiliated link system includes a host server rewriting each of a set of URLs corresponding to the site owner's key pages, such as the “default document” for the top level domain URL, as a processing script. The processing script processes Web client browser requests by checking a host server input variable, a referring server identifier, and a browser identifier file, thereby determining whether the referring server is an affiliated or a non-affiliated server, or whether the requesting client browser is an affiliated or a non-affiliated client. The processing script performs affiliated processing in response to the affiliated server or client, and processes the requested URL in response to the non-affiliated server or client. The host server serves the output to the requesting client browser.

In accordance with another aspect of the present invention, a method for operating a seamless affiliated link system includes browsing a referring website with a Web browser, checking an identifier of the referring website, determining the affiliation of the referring website in response to the identifier, linking the referring website to a host website including a plurality of Web pages, serving at least one of the plurality of Web pages in response to a non-affiliated website, and performing affiliated processing in response to an affiliated website.

In accordance with another aspect of the present invention, a method for operating a seamless affiliated link system includes browsing a host website by providing a Web browser with an encoded URL from an email or news client, from “bookmarks,” or by manual entry, checking an identifier of the encoded URL, determining the affiliation of the requesting client browser in response to the identifier, setting a cookie to identify an affiliated client browser, and redirecting the affiliated client browser to increase link traffic for a specified key page.

An advantage of the present invention includes that it has applications for building link popularity and link traffic for a site owner's key pages. A further advantage is that, in the future, search engines may use the present invention in unanticipated ways to the benefit of site owners. Additional advantages and features of the present invention will become apparent from the description that follows and may be realized by the instrumentalities and combinations particularly pointed out in the appended claims, taken in conjunction with the accompanying drawings.

### BRIEF DESCRIPTION OF DRAWINGS

For a more complete understanding of the present invention, reference will now be made to the embodiments illustrated in greater detail in the accompanying figures and described below by way of examples of the invention wherein:

FIG. 1 is a schematic view of the seamless affiliated link system in accordance with one embodiment of the present invention;

FIG. 2 is a logic flow diagram of a method for operating a seamless affiliated link system in accordance with FIG. 1;

FIG. 3 is a logic flow diagram of a method for operating a seamless affiliated link system in accordance with FIG. 1;

FIG. 4 is a logic flow diagram of a method for operating a seamless affiliated link system in accordance with FIG. 1;

FIG. 5 is a logic flow diagram of a method for operating a seamless affiliated link system in accordance with FIG. 1; and

FIG. 6 is a logic flow diagram of a method for operating a seamless affiliated link system in accordance with FIG. 1.

### DETAILED DESCRIPTION

The present invention is illustrated with respect to a seamless affiliated link system particularly suited to the public Internet. The present invention is however applicable to various other uses that may require seamless affiliated link systems, as will be understood by one skilled in the art.

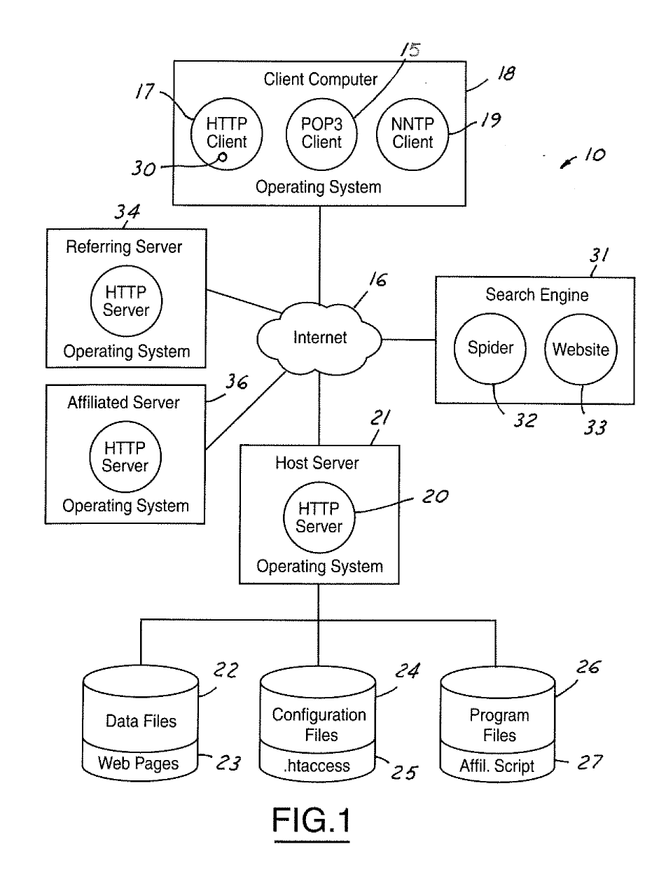

Referring to FIG. 1, a seamless affiliated link system 10 is illustrated operating in the context of any network using Internet application protocols such as Hypertext Transport Protocol (HTTP), Post Office Protocol 3 (POP3), and Network News Transport Protocol (NNTP), including the public Internet 16. The system 10 includes an HTTP host server 20 within a server operating system 21. The operating system 21 includes or is coupled to data files 22, configuration files 24, and program files 26. The host server 20 is connected to referrer servers 34, which may be affiliated servers 36, as well as affiliated clients, which may be HTTP clients 17 (including browsers 30), POP3 clients 15, and NNTP clients 19, within client operating systems 18, all through the Internet 16.

The HTTP host server 20 is included within a server operating system 21. The HTTP host server 20 processes HTTP client browser requests using server input variables (e.g. affiliate IDs), server environment variables (e.g. HTTP_REFERER), and browser identifier files (e.g. affiliate cookie files 28), and generates output for the client using data files 22 (e.g. Web pages 23), configuration files 24 (e.g. .htaccess), and program files 26 (e.g. an affiliate script 27). The HTTP host server 20 enables HTTP affiliated servers 36 and HTTP affiliated clients 15 to link directly to key Web pages, while tracking the traffic and/or orders for each affiliate.

The host server 20 is configured to rewrite the URLs for key Web pages, such as the default document for the top level domain URL, as a processing script, for example an affiliate script 27 named “cgi-bin/get-url.cgi.” Each host server may include a tailored method for engaging this. For example, to rewrite the default document for the top level domain on an Apache host server, the following statement would be included in a file named “.htaccess” placed in the directory of the top level domain: “directoryIndex <pathname>”, where <pathname> is the path to the desired file or script. Rewriting URLs for other key Web pages on an Apache host server might require the use of “mod rewrite” statements.

The host server 20 further includes an affiliate script 27 (e.g. get-url.cgi) checking an identifier of the referring server 34 to determine if the referring server 34 is a pre-defined affiliated server 36. This is currently done by checking the referring URL, as provided in the HTTP specified environment variable “HTTP_REFERER”. Future changes to the HTTP specification may provide different mechanisms for checking the identity of a referring server. For a positive response, the server 20 performs affiliated processing, such as the respective processing for the current link mechanism. Otherwise, the server 20 processes the originally requested URL, for instance by reading the standard default document for the top level domain (e.g. “index.html”) and outputting it to the browser 30. The host server 20 processes the originally requested URL, e.g. by reading and outputting (writing) a specified document, rather than redirecting the browser 30 to it. Redirecting the browser 30 could cause search engine spiders 32 to record the wrong URL (e.g. http://www.budgetlife.com/index.html) rather than the desired URL (e.g. http://www.budgetlife.com), or it could cause the host server 20 to go into a loop.

The host server affiliate script 27 further includes checking whether the requested URL is encoded with an affiliate ID. For a positive response, the server 20 sends a cookie 28 to the browser 30 and redirects the browser 30 to the site owner's specified key page, rather than performing affiliated processing immediately. In this way, the browser will request the key page from the host server 20, thus generating link traffic to the key page and again activating the affiliate script 27, which this time obtains a negative response to the check for an affiliate ID. For the negative response, the affiliate script 27 proceeds as described in paragraph[0026] if HTTP_REFERER is defined. If HTTP_REFERER is not defined, as is the case for URLs provided to the browser 30 by POP3 clients 15, by NNTP clients 19, from browser “bookmarks”, or by manual entry, the affiliate script 27 determines if the referring server 34 is an affiliated server 36, or if the requesting client is an affiliated client, by requesting the previously set cookie 28 from the browser 30. As described in paragraph [0026], the host server 20 performs affiliated processing for affiliated servers 36 and affiliated clients, e.g. 15, and processes the originally requested URL for non-affiliated servers, e.g. 34 and non-affiliated clients, e.g. 17.

The host server 20 of the seamless affiliated link system 10 causes any request from an affiliated server 36 or affiliated client 15 to generate the processing and output specified by the website owner for that specific affiliated server 36 or affiliated client 15. All other requests, even from search engine “spiders” 32, result in processing the originally requested URL, for instance by reading and outputting a specified document (e.g. “index.html”) to the browser client 17.

In this way, all affiliated links (many affiliates promote hundreds of them), which reside on affiliated servers 36, will contribute to both the link popularity and the link traffic of the site owner's key pages (e.g. http://www.budgetlife.com), and all affiliated links which are processed manually, or from browser bookmarks, or from non-HTTP (e.g. email) clients, will contribute to the link traffic of the site owner's key pages. This increases the apparent importance rating of these pages in results of a search at a search engine website 33.

The clients 15, 17, 19 include any Internet client within any client operating system 18. Although one client computer 18 is illustrated, the present invention is further embodied with a plurality of client computers 18 coupled to the Internet 16 generating requests therethrough for HTTP host server 20 information.

Affiliates operating affiliated servers 36 and generating affiliated clients 15 receive compensation depending on their affiliated links to the site owner's key pages. The present invention includes a processing script, termed an affiliate script 27, on the host server 20 hosting the site owner's key pages. This script checks the domain name of the website from which a user has linked to the site owner's key pages (i.e. the referring server 34). The script determines if the referring server 34 is one of the affiliated servers 36, or if the requesting client e.g. 17 is one of the affiliated clients, e.g. 15. If it is, the script activates affiliated processing, such as the respective processing for the current link mechanism.

If the referring server 34 is not one of the affiliated servers 36, and the requesting client, e.g. 17 is not one of the affiliated clients, e.g. 15, the affiliate script 27 processes the originally requested URL, for instance by reading the standard default document for the top level domain and outputting it to the browser 30 or search engine spider 32 that requested it.

As was previously mentioned, prior art cloaking scripts check for the Internet Protocol (IP) address of the “requester” (contained in the HTTP environment variable “REMOTE_HOST”), whereas the present invention checks the domain name (or IP address) of the referring server 34 (contained in the HTTP environment variable “HTTP_REFERER”).

The present invention includes setting a cookie in response to an encoded URL requested by an affiliated client 15 or referred by an affiliated server 36, and then redirecting the browser 30 to the site owner's specified key page. Advantages of the present invention include that it has applications for building link popularity and link traffic for a site owner's key pages. Search engines 31 use link popularity and link traffic to determine the “importance” of the page. In the future, search engines 31 may use the present invention in unanticipated ways to the benefit of site owners.

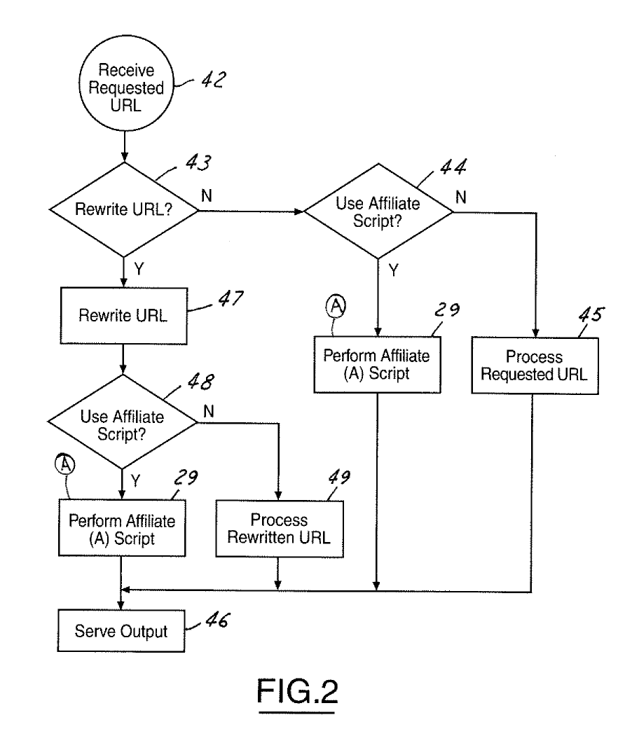

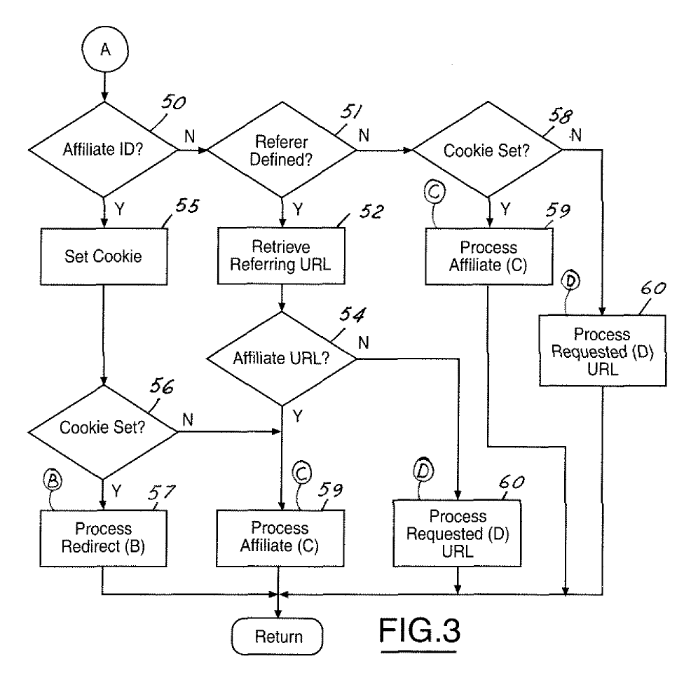

Referring to FIG. 2, a logic flow diagram of a method for operating a seamless affiliated link system 10 is illustrated. Logic starts in operation block 42 when the host HTTP server 20 receives a client request for a URL. In inquiry block 43, the server 20 checks whether the requested URL has been designated to be re-written. The invention uses the server configuration files 24 to specify such URLs. For a negative response in inquiry block 43, a check is made in inquiry block 44 as to whether the affiliate script 27 has been specified as the requested URL. For a negative response, in operation block 45, the server 20 processes the originally requested URL 42, and then, in operation block 46, serves the output back to the client 17. Otherwise, the server 20 passes control to the affiliate script 27 in operation block 29 (A), which is further detailed in FIG. 3.

For a positive response in inquiry block 43, the server 20 rewrites the requested URL in operation block 47. Different methods can be used to rewrite the URL 42. For instance, using the Apache HTTP server, the “mod_rewrite” module can be used to rewrite any URL. For a directory URL, the “Directoryindex” parameter can be used instead.

A check is made in inquiry block 48 as to whether the affiliate script 27 has been specified as the rewritten URL. For a negative response, in operation block 49, the server 20 processes the rewritten URL, and then, in operation block 46, serves the output back to the browser 30. Otherwise, the server 20 passes control to the affiliate script 27 in operation block 29 (A), which is further detailed in FIG. 3. The user of the invention defines the content of the various outputs, generated in operation blocks 45, 49, or 29 (A), to meet the user's specific requirements. The output is served to the browser 30 in operation block 46, which activates following operation blocks 45, 49 or 29 (A).

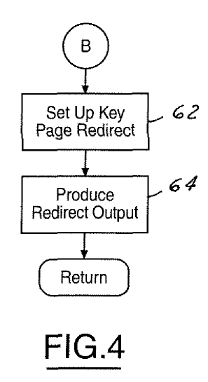

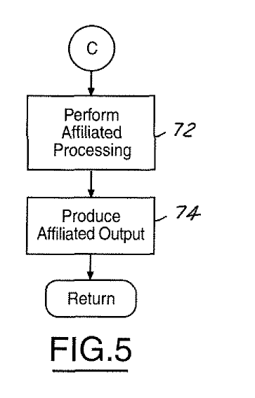

Referring to FIG. 3, the affiliate script 27, in inquiry block 50, checks whether the affiliate ID is defined, as it would be in an encoded URL. The invention employs encoded URLs and cookies when HTTP_REFERER is not defined, as is the case for URLs provided to the browser 30 by POP3 clients 15, by NNTP clients 19, from browser “bookmarks”, or by manual entry. For a positive response, in inquiry block 50, the affiliate script 27 “sets a cookie” in operation block 55, by sending the cookie file back to the browser 30. If the browser does not reject the cookie, as determined in inquiry block 56, the affiliate script processes a redirect in operation block 57 (B), which is further detailed in FIG. 4. Otherwise, the affiliate script 27 processes the affiliate in operation block 59 (C), which is further detailed in FIG. 5.

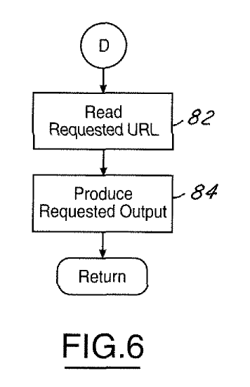

For a negative response in inquiry block 50, the affiliate script 27, in inquiry block 51, checks whether the referrer variable (HTTP_REFERER) is defined. For a negative response, it further checks, in inquiry block 58, if a cookie was previously set with the browser 30. If so, it processes the affiliate in operation block 59 (C), which is further defined in FIG. 5. If not, if processes the originally requested URL in operation block 60 (D), which is further illustrated in FIG. 6.

For a positive response in inquiry block 51, the affiliate script 27, in operation block 52, retrieves the referring URL on the referring server 34 from the host server's 20 environment variable “HTTP_REFERER”, as defined in the HTTP specification. The seamless affiliated link system 10 maintains a list of affiliated URL's specified for affiliated processing. This list may variously be maintained within the affiliate script 27, within the host server's data files 22, or in an external database. In inquiry block 54, if the referring URL is an affiliated URL, the affiliate script 27 processes the affiliate in operation block 59 (C), which is further detailed in FIG. 5. Otherwise, the affiliate script 27 processes the originally requested URL 42 in operation block 60 (D), which is further detailed in FIG. 6.

Referring to FIG. 4, the affiliate script 27, in operation block 62, sets up a redirect to the key page specified by the site owner, and then produces the redirect output in operation block 64. The script processes a redirect, rather than processing the originally requested URL, to generate link traffic to the site owner's key pages.

Referring to FIG. 5, the affiliate script 27, in operation block 72, performs affiliated processing, such as the respective processing for the current link mechanism, and then produces the affiliated output in operation block 74.

Referring to FIG. 6, the affiliate script 27, in operation block 82, reads the requested URL, and then produces the requested output in operation block 84. Usually, this will be reading and writing a specified page (e.g. “index.html”). However, HTTP emulation will sometimes be required, such as for pages that include “server side includes” or PHP requests. The affiliate script 27 processes the originally requested URL, rather than redirecting the browser to it, to generate link popularity and link traffic for the site owner's key pages.

In operation, the method for operating a seamless affiliated link system 10 includes providing a browser with encoded URLs from bookmarks, manual entry, or non-HTTP clients such as POP3 clients and NNTP clients, setting a cookie and redirecting the browser to key pages in response to said URLs, and then processing the redirected URLs. The method further includes browsing a referring server 34 website or a host server website with a Web browser 30, checking an identifier of the referring server 34 website or requesting client 17 browser, determining the affiliation of the referring server 34 website or requesting client 17 browser in response to the identifier, linking the referring server 34 website or requesting client browser 30 to a host server website including a plurality of Web pages, serving at least one of the plurality of Web pages, by processing the requested URL, in response to a non-affiliated server, e.g. 34 website or non-affiliated client browser 30, performing affiliated processing in response to an affiliated server 36 website or affiliated client 15 browser, and serving the output to the Web browser 30.

From the foregoing, it can be seen that there has been brought to the art a new seamless affiliated link system 10. It is to be understood that the preceding descriptions of various embodiments are merely illustrative of some of the many specific embodiments that represent applications of the principles of the present invention. Numerous and other arrangements would be evident to those skilled in the art without departing from the scope of the invention as defined by the following claims.

1. A method for operating a seamless affiliated link system comprising:
defining a set of key uniform resource locators (URLs) to be rewritten by a host server as a processing script;
defining said set of key URLs to correspond to a set of key page documents as a function of said processing script;
defining a set of encoded URLs as affiliated URLs;
defining a set of referring servers as affiliated servers;
defining a set of identifier files to correspond to said affiliated URLs;
defining said set of identifier files to identify client browsers requesting said affiliated URLs as affiliated clients;
defining said processing script to process requests for said key URLs, said encoded URLs, and said affiliated clients; and
checking an identifier file for a pre-defined affiliated status.

2. The method of claim 1, wherein checking said identifier for said pre-defined affiliated status further comprises at least one of: checking an identifier of an encoded URL for pre-defined affiliated URL status, checking an identifier of a referring server for pre-defined affiliated server status, or checking an identifier file of a requesting client browser for affiliated client status.

3. The method of claim 1 further comprising:
reading one of said set of key page documents in response to a non-affiliated server or, if affiliated server status cannot be determined, in response to a non-affiliated client.

4. The method of claim 3 further comprising:
processing said requested key page document and writing the output to a client browser.

5. The method of claim 1 further comprising:
sending an identifier file to a requesting client browser (currently “setting a cookie”) in response to said affiliated URLs to identify said requesting client as an affiliated client.

6. The method of claim 5 further comprising:
redirecting said affiliated clients to increase link traffic for said specified key page document.

7. The method of claim 1 further comprising:
performing affiliated processing in response to said affiliated server or said affiliated client as a function of said processing script.

8. The method of claim 7 further comprising:
specifying affiliated output for said affiliated server or said affiliated client, wherein said processing script generates a custom output for a host server to provide to a client browser.

9. The method of claim 1 further comprising:
recording said requested key page document as a uniform resource locator in a search engine.

10. The method of claim 1 further comprising:
processing client Web browser requests using at least one of server input variables, server environment variables, or browser identifier files; and
generating output to a client using at least one of data files, configuration files, or custom program files.

11. A method as in claim 1 further comprising:
generating an increased importance value of key uniform resource locators for search engines that determine said importance as a function of links and referrals thereto from said referring server or other Web servers.

12. A method as in claim 1 further comprising:
retrieving an identifier through said processing script from a server input variable;
specifying sending an identifier file to the Web browser or checking for a referring server URL as a function of said identifier;
retrieving a referring server URL through said processing script from a server environment variable defined in an HTTP specification;
specifying, through said referring server URL, at least one of a processing function to perform or a Web page to process;
requesting an identifier file from said Web browser as a function of a lack of said referring server URL;
retrieving said identifier file from said Web browser, and using said identifier file to specify processing to perform; and
serving said Web page in response to a lack of said identifier file.

13. A seamless affiliated link system comprising:
a host server rewriting each of a set of URLs as a processing script, said processing script processing a Web browser request by checking a host server input variable, a referring server identifier, and a browser identifier file, thereby determining whether said referring server comprises an affiliated server or a non-affiliated server, or whether said browser comprises an affiliated browser or a non-affiliated browser, said processing script performing affiliated processing in response to said affiliated server or affiliated browser, said processing script processing said URL in response to said non-affiliated server or non-affiliated browser, and said host server serving said output to said requesting browser.

14. The system as in claim 13 further comprising:
a client browser requesting a Web page, which activates said referring server; and
an affiliated client browser requesting a Web page, which activates said host server.

15. The system as in claim 14, wherein said referring server comprises said affiliated server referring a request from said client browser to said host server.

16. The system as in claim 14, wherein said referring server comprises said non-affiliated server referring a request from said client browser to said host server.

17. The system as in claim 14, wherein affiliated output is specified within said host server for said affiliated server or said affiliated client, and wherein output specified by said requested URL is generated for said non-affiliated server or non-affiliated client, and wherein said host server serves said output to a client browser as a function of said identifiers.

18. The system as in claim 13, wherein a search engine spider locates a referring server or said host server.

19. The system as in claim 13, wherein said Web browser activates a search engine server that locates either a referring server or said host server.

20. The system as in claim 13, wherein said host server and said Web browser operate on a network using HTTP, POP3, or NNTP.

21. The system as in claim 13, wherein said host server processes client Web browser requests using at least one of server input variables, server environment variables, and browser identifier files, and said host server generates output to said client using at least one of data files, configuration files, and custom program files.

22. A method for operating a seamless affiliated link system comprising:
requesting a URL from at least one of a referring server or host server with a Web browser;
checking identifiers of at least one of said requested URL, said referring server, and said requesting Web browser;
sending an identifier file and redirecting said requesting Web browser to a specified key page in response to said requested URL identifier;
determining the affiliation of said referring server or said requesting Web browser in response to said identifiers;
linking said referring server or said requesting browser to a host server comprising a plurality of Web pages;
serving at least one of said plurality of Web pages in response to a non-affiliated server or non-affiliated browser; and
performing affiliated processing in response to at least one of an affiliated server or an affiliated browser.

23. A method as in claim 22, wherein checking said referring identifier further comprises checking a domain name or an Internet Protocol address.

24. A method as in claim 22 further comprising:
specifying said affiliated server or said affiliated browser for affiliated processing and output, wherein said affiliated processing generates a custom output for a host server to provide to a client browser.

25. A method as in claim 22 further comprising:
retrieving said requested URL identifier through said processing script from a host server input variable, as defined in an HTTP specification;
retrieving said referring server identifier through said processing script from a host server environment variable, as defined in an HTTP specification; and
retrieving said requesting Web browser identifier through said processing script from a browser identifier file, as defined in an HTTP specification.
